(19) United States
(12) Patent Application Publication
(10) Pub. No.: US 2026/0097931 A1
(43) Pub. Date: Apr. 9, 2026

(54) Lifting System for Wooden Construction Elements

(71) Applicant: Simpson Strong-Tie S.A.S., Saint Gemme La Plaine (FR)

(72) Inventors: Jacob Moldrup Hansen, Odder (DK); Samuel Boussiron, Saint Gemme La Plaine (FR); Mathieu Luro, Saint Gemme La Plaine (FR)

(21) Appl. No.: 19/112,958

(22) PCT Filed: Sep. 15, 2023
(86) PCT No.: PCT/EP2023/075499

§ 371 Date: Mar. 18, 2025

(30) Foreign Application Priority Data
Sep. 18, 2022 (GB) 2213676.6

(51) Int. Cl. B66C 1/66

(52) U.S. Cl. CPC B66C 1/66

(57) ABSTRACT

The present invention relates to a lifting system (1) for lifting wooden construction elements e.g. cross laminated timber (CLT) elements, comprising a rod (3) defining a longitudinal axis, a first end section and a second end section, a lifting element (9) connected to the rod, the lifting element comprising a lift section (10) arranged to receive a hook, a rope, a wire or similar lifting equipment, and a number of dowels (7), the dowels defining a first dowel section and second dowel section, the first and second dowel section being connected via a common section, wherein the rod comprises a number of rod holes arranged to receive the dowels, and wherein the lifting element is adapted to be detachably connected to the rod.

The present invention relates to a lifting system for lifting wooden construction elements e.g. cross laminated timber elements

### BACKGROUND

In the building industry, a large variety of materials are used for the construction of a building. For many years, concrete has been the most predominant material for high-rise buildings where large precast slabs are used for forming at least the interior walls and floor decks.

Due to the increased focus on sustainability, other materials than concrete have become increasingly in demand from architects and developers. Such material could be wood since wood is practically CO₂ neutral. However, the benefits of prefabricated slabs have been so beneficial and so integrated in the construction industry that it has been evident that in order for wood to become popular, wood should still facilitate prefabricated slabs. This demand has caused the development of cross laminated timber (CLT) elements that in many ways provide the same opportunities for prefabricating the slab to a specific design e.g. preparing the slabs for doors, windows, ventilation and electricity already during the production process.

CLT elements benefits from many of the same properties as the concrete slabs i.e. a high stress modulus, and hence the architects and developers need not change much of their thinking when building. As a rule of thumb, the weight of a CLT slab compared to a concrete slab is typically about half, depending on various properties. Furthermore, since the CLT elements are made of wood, it is much easier to handle small adaptions directly on site, if necessary.

When handling a concrete slab on site, a large crane needs to lift the slab in place. The lifting eyes or lifting holes need to be precast, i.e. embedded into the concrete, in order to have sufficient lifting capacity and require removing after use. Alternatively, large and heavy lift or fork like arrangements may be used.

Removing the embedded eyes as well as the use of heavy lifts or fork-like arrangements for concrete slabs is expensive both in terms of the manufacturing process or the equipment itself and also in terms of logistics and handling.

Ensuring that the heavy lifts or fork-like arrangements are at the building site is costly and easily puts a halt to the construction process if they are not at site in due time.

The present invention addresses the above disadvantages and drawbacks of the prior art. More specifically, the present invention provides an improved lifting system that can be mounted on site to the element in question.

The present invention also provides a lifting system that may at least partly be used as the construction integrity in the final structure of the building.

The present invention also provides a lifting system that is cheap and easy to handle logistically.

In one aspect, the present invention provides a lifting system for lifting wooden construction elements e.g. cross-laminated timber elements, comprising:
a rod defining a longitudinal axis, a first end section and a second end section,
a lifting element connected to the rod, the lifting element comprising a lift section arranged to receive a hook, a rope, a wire or similar lifting equipment, and
a number of dowels, the dowels defining a first dowel section and second dowel section, the first and second dowel section being connected via a common section, wherein the rod comprises a number of rod holes arranged to receive the dowels, and wherein the lifting element is adapted to be detachably connected to the rod.

In this way, it is possible to attach the rod to the element using the dowel as an anchor inside the element. A receiving hole is drilled in the element, and a dowel hole or a number of dowel holes are drilled perpendicular to the receiving hole. The rod is inserted in the receiving hole, and hence the rod holes in the rod are oriented so as to have the centre axis of the rod holes substantially concentric with the dowel holes. In this way, it is achieved that the dowels can be inserted in the dowel holes in the element and the dowel further is received in the rod hole in the rod. When the dowel is inserted in the rod hole, an anchor is formed inside the element, and thereby the rod is affixed to the element and can no longer be drawn out of the receiving hole unless the dowels are removed. It is to be understood that the rod may be affixed to the element using a single dowel or more dowels. The lifting element is attached to the rod in order to facilitate that a hook or sling or similar lifting equipment can easily be attached to the rod. The lifting element is attached in a way that easily facilitates removal of the lifting element. Having lifted the element in its desired position, the lifting element can easily be removed, and the rod projecting from the element can now be used for attaching the CLT element to another construction element e.g. a second element. In this way, it is achieved that the rod which is securely affixed to the element by the dowels now serves a second purpose and hence needs not be removed. This saves time for the workers on site, and it further speeds up the construction time since the parts for at least the initial joining of e.g. two elements is already mounted i.e. a rod is already affixed to the one element just needing to be finally affixed to the second element. The second element to be joined with the first element only needs to have a receiving hole and dowel holes and would then be ready to be joined.

The dowel holes and/or the receiving hole may be filled with a resin or epoxy prior to the insertion of rod and dowels. In this way, an even stronger connection is achieved. It is to be understood that the lifting system may be used for any kind of wooden elements such as CLT elements, sub-assemblies or beams. In the present application, mainly CLT element are discussed but other elements may be lifted in an equal manner.

Moreover, the rod may comprise a thread at least partially along the longitudinal rod axis.

In case a resin is used to increase the contact surface of the rod, the strength of the connection between the CLT element and the rod thereby increases. Furthermore, it is possible to use a nut or similar to keep the lifting element in place in relation to the rod.

Additionally, the lifting element may comprise a hole arranged to receive a part of the rod.

The hole facilitates that the lifting element is slid on the rod via a threadless hole in the lifting element, thereby achieving a more secure pulling direction between the rod and the lifting element. The hole in the lifting element and the thread of the rod then facilitates that the lifting element is slid on the rod via a threadless hole in the lifting element and a nut keeps the lifting element in position, i.e. keep the lifting element from sliding off again.

Furthermore, the lifting element may comprise a through hole arranged to receive a hook, a shackle, a sling or similar lifting equipment.

In this way, it is possible to attach a large variety of lifting equipment to the lifting element. The through hole may be an eye that makes it particularly easy to attach a hook to the lifting element.

In addition, the hole in the lifting element may comprise a thread matching a thread of the rod.

In this way, it is achieved that the lifting element may be attached to the rod in more ways. When the rod comprises a thread, the lifting element may simply be screwed onto the rod when the lifting element has a thread matching the rod.

Also, the lifting system may further comprise a nut to keep the lifting element fixated in relation to the rod.

A nut facilitates that the lifting element can be secured to the rod or in relation to the rod. If the lifting element comprises a thread matching the thread of the rod, the nut will, when tightened to the lifting element, act as a contra nut ensuring that the lifting element is kept in a fixed position. In this way, the nut prevents the lifting element from loosening in relation to the rod. If the lifting element does not have a thread, the nut will ensure that the lifting element is kept in position i.e. fixated in relation to the longitudinal axis of the rod.

Moreover, one or more of the dowels may comprise locking means for preventing the dowel to slide out of the rod hole.

In this way, it is achieved that the dowel can be used to lock the lifting element in relation to the longitudinal axis of the rod, i.e. preventing the lifting element to slide of the rod when the CLT element is lifted via the lifting element.

In addition, the rod holes in the first end section of the rod may be turned 90° in relation the rod holes in the second end section of the rod.

In this way, it is achieved that the lifting system can be used for joining more types of elements. Furthermore, when e.g. two beams are connected using the lifting system, it is possible to ensure that the dowel holes can be oriented in such way that they are pretected from the surrounding environment and furthermore the may be hidden and hence not visible.

Further, one or more rod holes may be oblong.

In this way, it is achieved that a dowel can be inserted in the rod hole over a longer distance in the direction of the longitudinal axis of the rod. Hence, the rod hole can compensate for variations in the position of the rod holes in relation to the dowel holes.

Additionally, the diameter of one or more of the dowels may change over the length of the dowel.

In this way, it is possible to use the dowels to pull the rod and hence the element to which the rod is affixed towards a second element to which the element is to be joined. Hence, it is possible to close gaps and ensure a firm joining.

Also, the rod may be tubular.

In this way, it is achieved that the rod is made from less material and therefore is lighter. Hence, the lifting system has a smaller CO₂ footprint. Furthermore, the workers handling the lifting system need to carry a smaller weight.

Moreover, the lifting system may further comprise a compression plate, the compression plate being detachably arranged between the lifting element and the part to be lifted.

In this way, it is achieved that the lifting element is kept in position and causes no damage to the element during the lifting process. During the lifting process, the rod can flex, and this flexing is minimised if the lifting element cannot be impressed in the element to be lifted.

Furthermore, the lifting system may comprise a spacer arranged between fastening means and the lifting element.

In this way, it is possible to minimise the gap between the lifting element and the element to be lifted. When lifting in the lifting element, the lift is often carried out in an angle. Such angle causes a torque to be subjected to the rod. The smaller the distance between the lifting element and the rod, the smaller the torque subjected to the rod. When using the spacer it is achieved that the lifting element is easily and quickly forced towards the element to be lifted. The workers handling the lifting element only need to mount the spacer and then tighten the nut a relatively short distance along the longitudinal axis of the rod.

In addition, the lift section of the lifting element may be arranged at a distance from the rod in a plane substantially parallel with the longitudinal axis of the rod. In this way, it is achieved that it is easier to connect the lifting equipment to the lifting element. In case the lifting equipment is pulling in lift section at an angle in relation to the rod, it is achieved that the point of attack of the resulting force subjected to the rod is moved towards the element to be lifted i.e. towards the position where the rod is inserted in the element. This minimises the risk of bending the rod during the lifting process, i.e. the rod is subjected to a smaller torque.

Additionally, the lift section may be an eye and/or a projecting pin arranged to facilitate a secure connection to a hook, a rope, a wire or similar lifting equipment.

In this way, a simple connection between the lifting system and the lifting equipment is achieved without blocking the properties for joining of elements.

Moreover, the rod may comprise three or more rod holes. In this way, the contact surface of the element to be lifted is increased.

Furthermore, the oblong rod hole may have the outline of two combined holes arranged eccentrically, the two holes having different diameters. In this way, it is achieved that a dowel inserted in the oblong rod hole pulls the two elements to be joined closer together.

In addition, the two rod holes are arranged in the one half of the rod, and the third rod hole is arranged in the opposite end quarter of the rod. In this way, it is achieved that the rod is securely connected to the both the first and second element.

Also, the first end section of the rod may comprise two rod holes. In this way, it is achieved that the first end section of the rod may receive differently arranged lifting elements e.g. having different heights. Furthermore, the first end section of the rod may be secured in a strong manner to the second element when having two rod holes arranged for receiving dowels.

Moreover, the one dowel section may have a different diameter than the other. In this way, it is achieved that upon inserting the dowel in the rod hole, the dowel forces the rod in a desired direction. The dowel may be inserted in the rod hole in a way so that the centre axis of the dowel is eccentrically arranged in relation to the centre of the rod hole. When the dowel is forced fully into the rod hole, the dowel will relocate, and the centre axis of the dowel will become concentric with the centre axis of the rod hole. If the dowel is kept in position, this will result in the rod being pulled in the desired direction.

Further, the common dowel section may have a larger diameter than at least one of the first or second dowel sections. In this way, it is achieved that the dowel may be inserted in the rod hole having either the one or the other end first and still pull the rod in a desired direction when the dowel is fully inserted.

In addition, the rod may be made of metal, non-metal composites or mixtures thereof. In this way, it is achieved that specific properties for resisting stress, strain or torque that are different from the lifting situation to the joining situation may all be enhanced.

By providing a lifting system which has a detachable lifting element, it is possible to utilise the rod as anchors for attaching one wooden construction element with another wooden construction element. The lifting system may thereby be utilised to lift the wooden construction element into its correct position at the construction site, and by removing the lifting element from the rod, the part of the rod that was connected to the lifting element may be exposed while still being anchored inside the wooden construction element. The exposed part of the rod i.e. the first end section of the rod, may then be inserted into prefabricated receiving holes in a second wooden construction element. Then a dowel may be utilised to anchor the rod to the second wooden construction element or in fact any construction element.

Thus, the rod of the lifting system may have a dual functionality, where the rod on the one hand may be used to connect the construction element to a lifting element and thereby handable for a crane or other hoisting devices, while on the other hand the rod may be utilised to secure one construction element to a second construction element.

This means that a plurality of wooden construction elements may be attached and/or secured to each other by using simple means. Thereby, it is possible to reduce construction time significantly, as the rod of the lifting system may be transformed into an attachment member by positioning a second construction element onto the rod after removing the lifting element. In this way providing a secure attachment by inserting a dowel into the second construction element to prevent the first wooden construction element to move relative to the second construction element in a direction parallel to the longitudinal axis of the rod.

The lifting system may in one embodiment have a rod, having a first outer diameter, where the lifting element is attached to an outer circumference of the rod, so that the lifting element has an opening having a first inner diameter that is equal to or larger than the first outer diameter of the rod.

The lifting element may in its operational state be in a fixed longitudinal position relative to the rod, so that an application of force in a direction of the longitudinal axis of the rod prevents any movement of the lifting element in a direction towards the first end section and/or the second end section of the rod.

When the rod is inserted into the wooden construction element, the dowel may be inserted into the dowel holes, where the dowel penetrates the rod holes and prevents the rod from being moved relative to the wooden construction element in a direction that is parallel to the longitudinal axis of the rod.

In one embodiment, the lifting system comprises at least a first and a second rod, two lifting elements, at least one wooden construction element having a first receiving hole to receive the first rod and a second receiving hole to receive a second rod, where each receinving hole has at least one dowel hole that is arranged perpendicular to a longitudinal axis of the receiving hole, where each dowel hole comprises at least one dowel that extends through the at least one rod hole of the rod.

The dowel hole in the construction element may extend on two sides of the receiving hole of the wooden construction element, providing a dowel hole configured to receive a dowel on at least two sides of a recieving hole as well as on two side of the rod hole. Thus, the centre axis of the dowel hole extends through the rod hole, so that one end section of the dowel is on one side of the rod hole, while the opposite end section of the dowel is on an opposite side of the rod hole.

In one embodiment, the lifting element is removably attached (detachable) in a direction parallel to the longitudinal axis of the rod. Thus, the lifting element may be attached to the rod by introducing it in a direction parallel to the longitudinal axis, where it may be removed by moving it in the opposite direction.

This lifting system is possible since the low weight of a CLT element reduces the need for heavy equipment or lifting eyes embedded in the element during the manufacturing process.

It is a further aspect of the present invention that during the manufacturing process, the manufacturers do not necessarily know how the elements are best lifted on site and therefore embedding lifting eyes is not a relevant option for CLT elements.

The present invention is described below in further detail, by way of example only, with reference to the accompanying schematic drawings, in which:

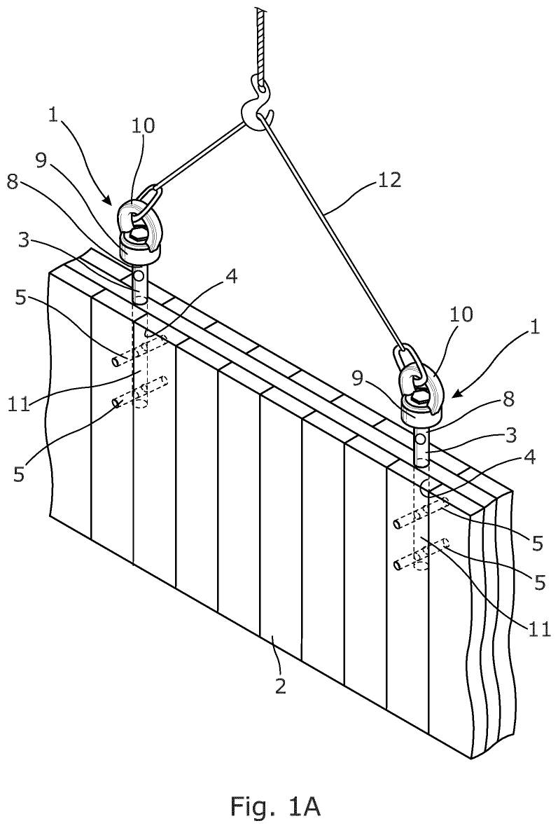

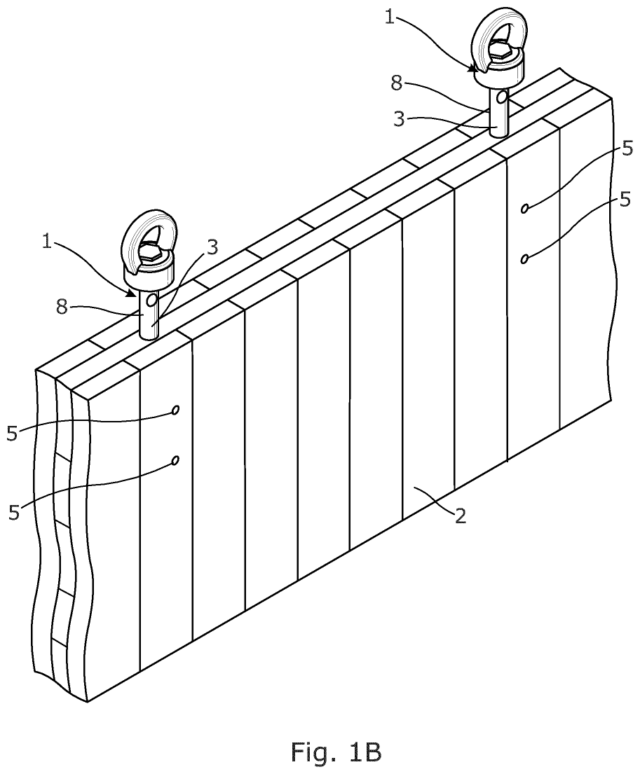

FIG. 1A shows in a partly see-through view an embodiment of the lifting system according to the present invention lifting a CLT element in an upright position,

FIG. 1B shows an embodiment of the lifting system arranged for lifting a CLT element,

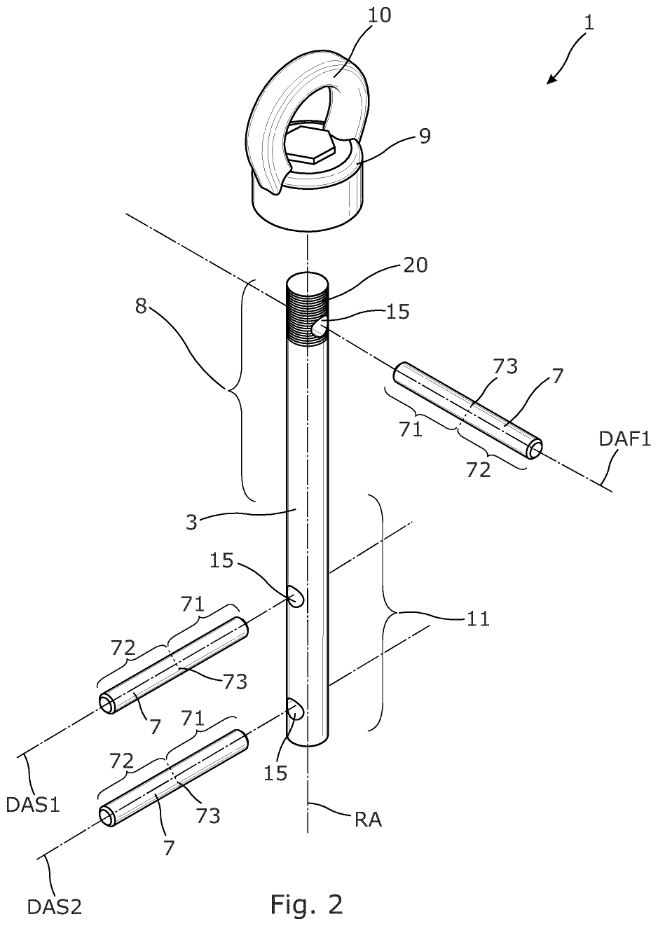

FIG. 2 shows in an exploded view an embodiment of the lifting system,

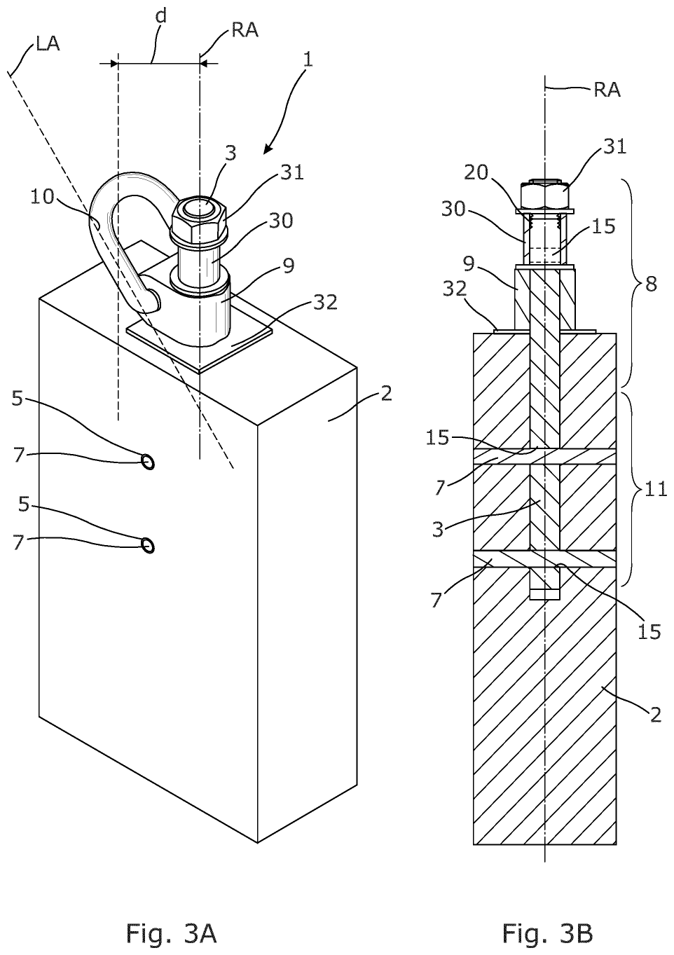

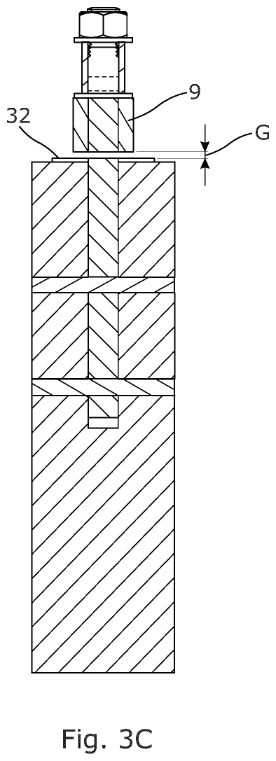

FIG. 3A shows in a perspective view an embodiment of the lifting system,

FIGS. 3B and 3C show in a cross-sectional view the lifting system shown in FIG. 3A,

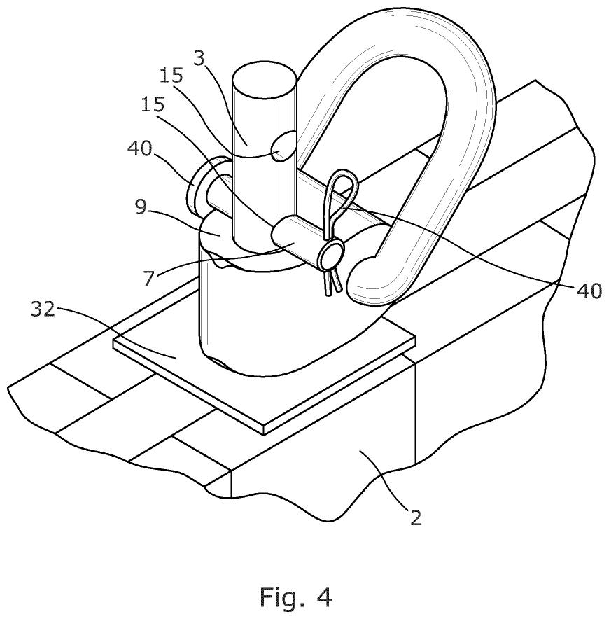

FIG. 4 shows in a perspective view a further embodiment of the lifting system,

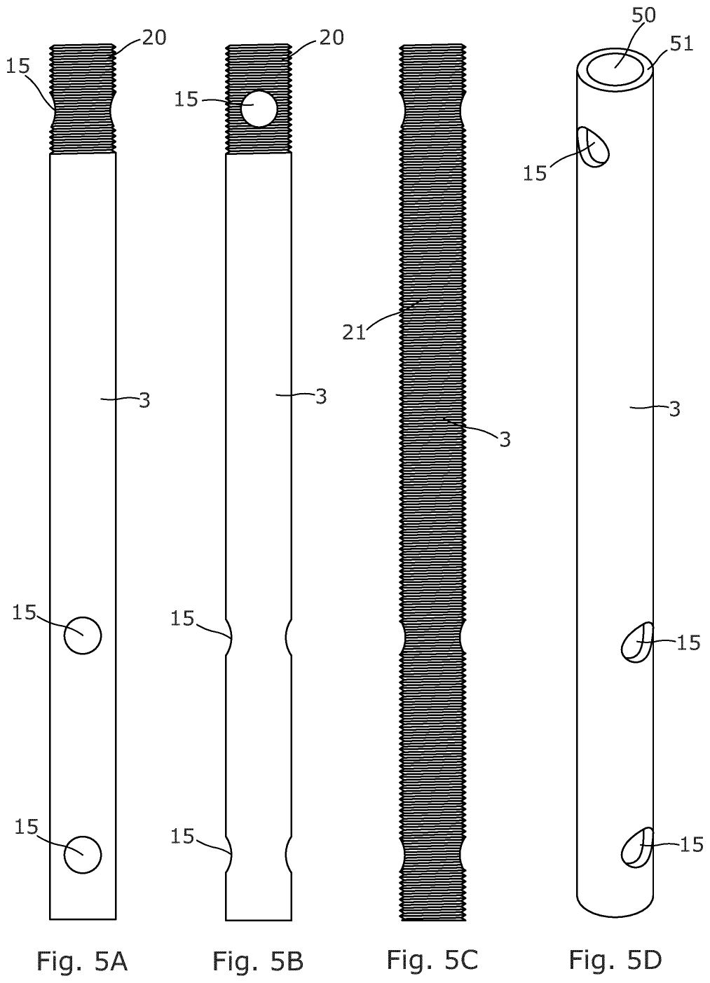

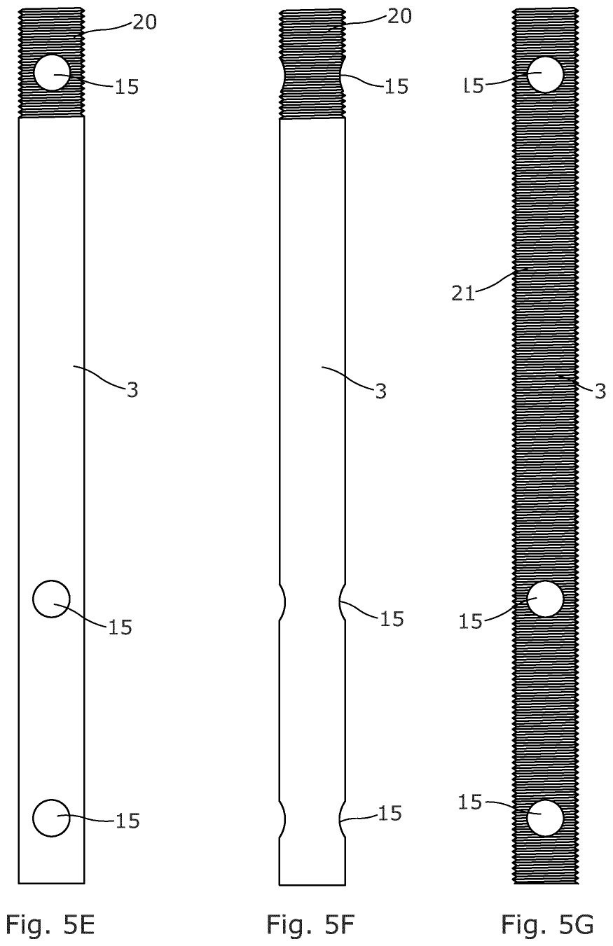

FIG. 5A-5G show different views and different embodiments of the lifting rod,

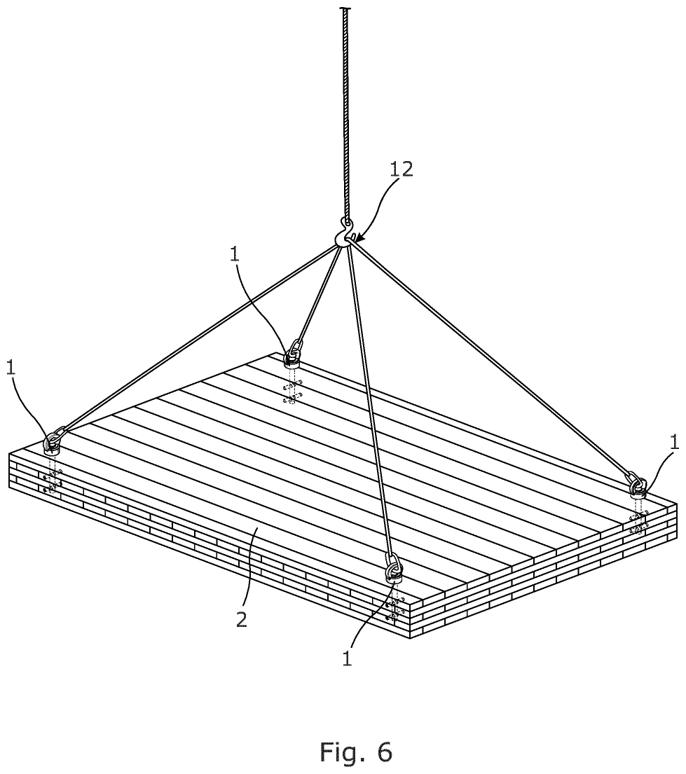

FIG. 6 shows in perspective view the lifting system according to the present invention, lifting a CLT element in a horizontal position,

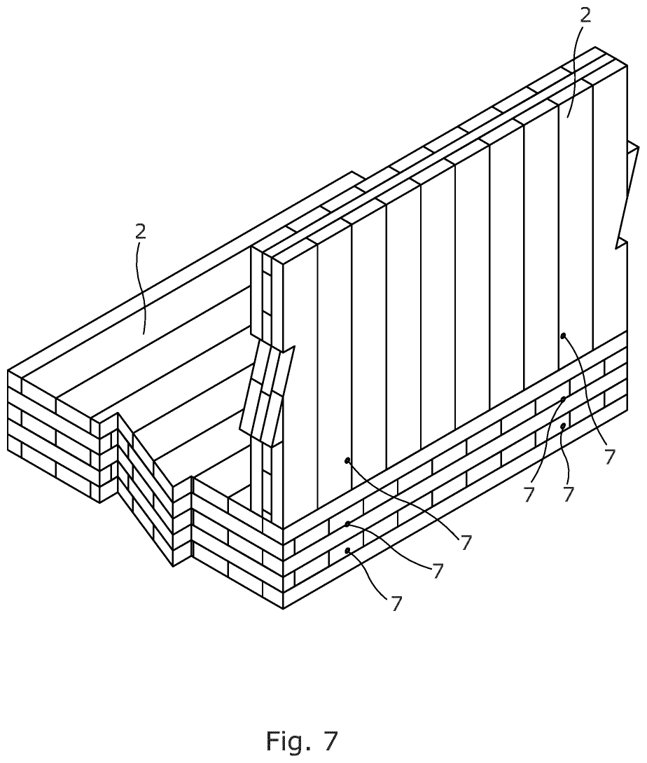

FIG. 7 shows in a perspective view two CLT elements assembled in a perpendicular manner by the lifting system according to the present invention.

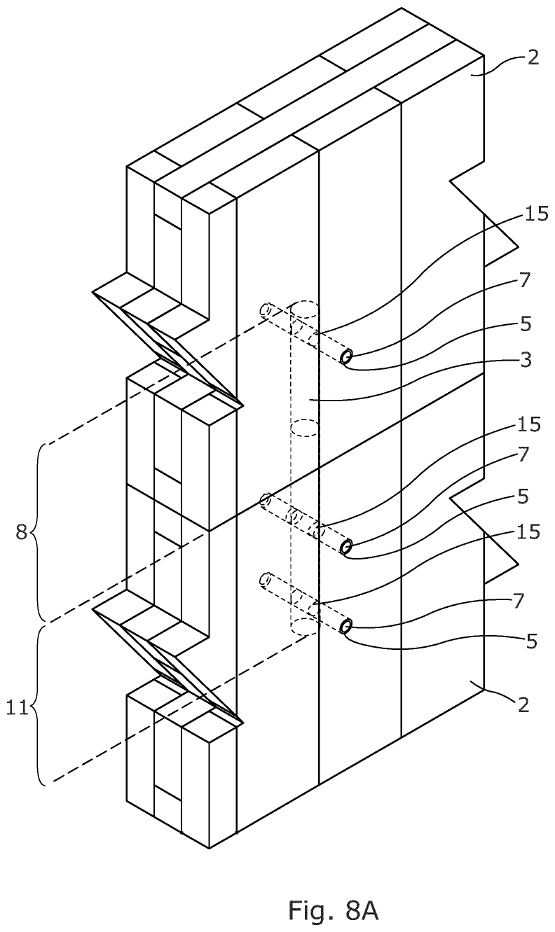

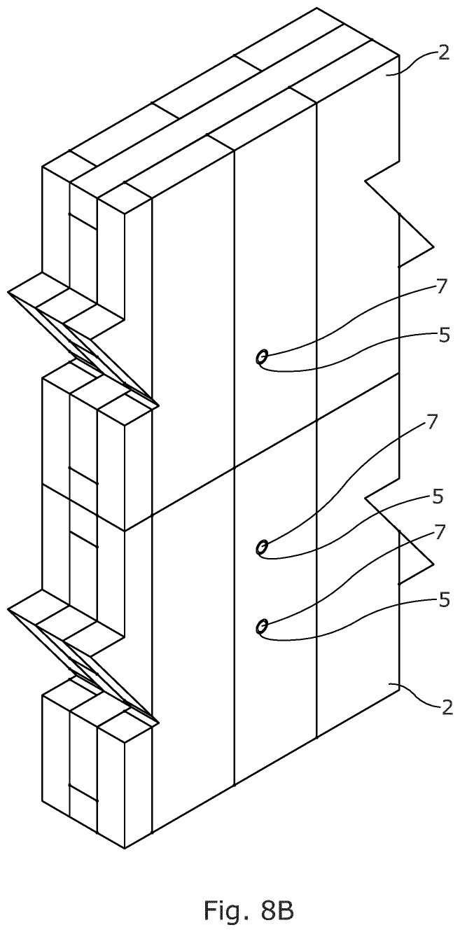

FIG. 8A shows in a perspective partly see-through view two CLT elements assembled in a planar manner, i.e. short edge to short edge,

FIG. 8B shows in perspective view the assembly shown in FIG. 8A i.e. without being see-through,

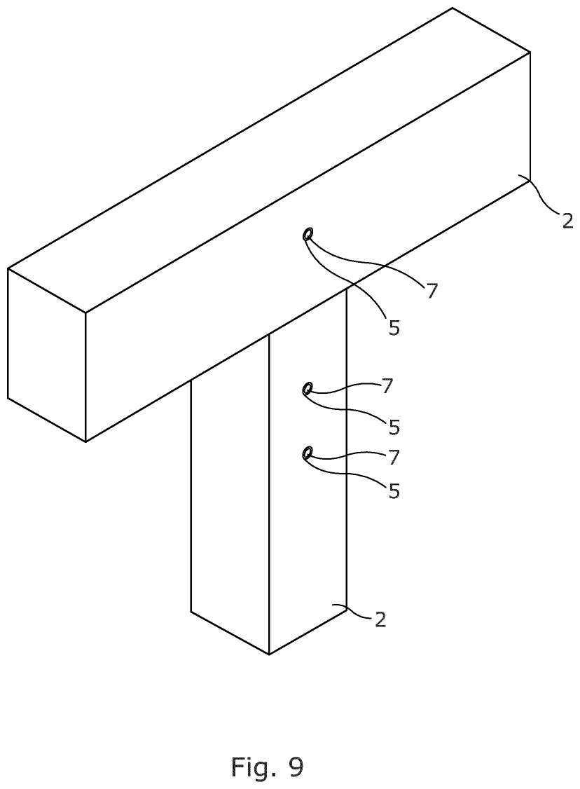

FIG. 9 shows in a perspective view the lifting system used for assembling a first beam with a second beam,

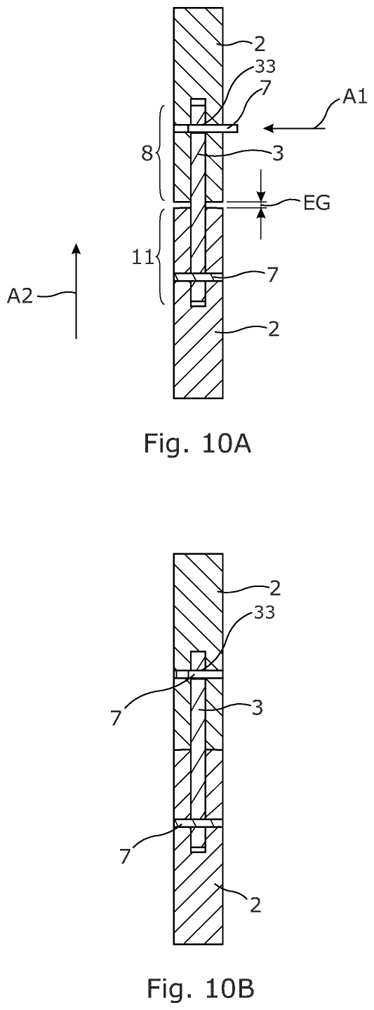

FIG. 10A-10B show an embodiment of the lifting system according to the present invention for drawing two CLT elements towards each other upon assembly,

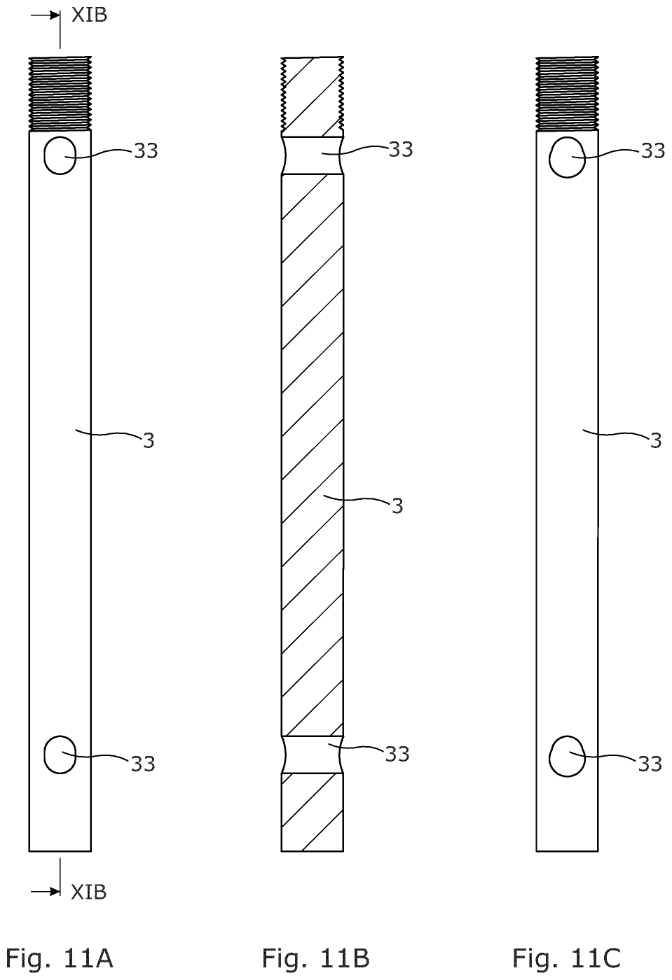

FIG. 11A-11C show an embodiment of the lifting rod having a different shaped dowel hole, and

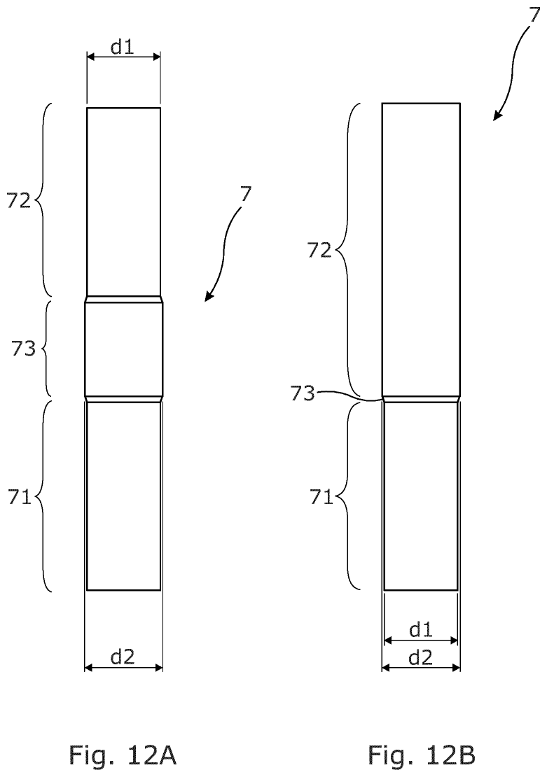

FIG. 12A-12B show two embodiments of the dowel.

All the figures are highly schematic and not necessarily to scale, and they show only those parts which are necessary in order to elucidate the present invention, with other parts being omitted or merely suggested.

FIG. 1A shows two lifting systems 1 lifting a wooden element 2 in form of a CLT element. The lifting system 1 is only partly visible since part of the rod 3 is embedded in the CLT element 2. The rod 3 is inserted in the receiving hole 4 shown with dotted lines. Similarly, shown with dotted lines two dowel holes 5 are shown adapted to receive dowels 7 (not visible). Mounted on the first end section 8 of the rod, a lifting element 9 is attached. The lifting element 9 comprises a lift section 10 which in this embodiment is a lifting eye. The second end section 11 of the rod 3 is positioned in the receiving holes 4 in the element 2. Attached to the lift section 10, i.e. the lifting eye, lifting equipment 12 is attached. It is to be understood that the lifting equipment 12 could have many forms e.g. having a hook directly connected to the lift section 10.

FIG. 1B shows the lifting situation of FIG. 1A without the lifting equipment and without the indication of the embedded parts and the receiving hole. It is shown that only the first end section 8 of the rod 3, the dowel holes 5 and the lifting element are visible.

FIG. 2 shows the lifting system 1 in an exploded view. The lifting system 1 comprises a rod 3 defining a longitudinal axis RA having a first end section 8 and a second end section 11. The lifting element 9 can be connected to the rod 3 by a threaded part 20 of the rod 3. The lifting element 9 is shown comprising the lift section 10 arranged to receive a hook, a rope, a wire or similar lifting equipment. Three dowels 7 are shown where the dowels 7 each defines a first dowel section 71 and second dowel section 72 where the first and second dowel section 71, 72 are connected via a common section 73. The rod comprises three rod holes 15 arranged to receive the dowels 7. It is shown that the lifting element 9 is adapted to be detachably connected to the rod i.e. in this embodiment by screwing the lifting element 9 onto the threaded part 20 of the first end section 8 of the rod 3. The lifting element 9 comprises an internal thread matching the thread of the rod 3. Each of the dowels 7 defines a dowel axis DAS1, DAS2 and DAF1. In this embodiment, the dowel axis are concentric with the centre of the rod holes 15.

FIG. 3A shows in a perspective view of a lifting systems 1 comprising another embodiment of the lifting element in its mounted state. FIG. 3B shows a cross-sectional view through the rod 3 of the lifting system shown in FIG. 3A (the lift section 10 is not visible).

In the shown embodiment, the lifting element 9 comprises a lift section 10 where the lift section 10 is offset a distance d from the rod axis. Furthermore, the lift section 10 is attached to the lifting body of the lifting element 9 at an angle defined between the lifting axis LA of the lift section 10 and the rod axis RA. In this way, it is achieved that when lifting e.g. by a hook in the lifting section the resulting force is directed towards the contact point between the lifting element 9 and the element 2 to be lifted. The lifting element 9 is slid on the rod 3, and a spacer 30 is mounted onto the rod 3, and finally a nut 31 is mounted to the thread 20 (se FIG. 3B) of the rod 3. In this way, the lifting element 9 is forced towards the element 2 to be lifted. Further, in this embodiment, a compression plate 31 is shown. The compression plate 32 facilitates that the load from a tilting lifting element 9 is withstood.

FIG. 3B shows a cross-sectional view in which the features found in FIG. 3A are numbered in the same way as in FIG. 3A. In this view, it is more visible that the dowels 7 are inserted in the element 2 through the dowel holes 5 and through the rod holes 15 in the second end section 11 of the rod 3. A rod hole 15 is also visible (dotted lines) in the first end section 8 of the rod but this rod hole is not in use during the lifting process in this embodiment, i.e. in FIG. 3A it is hidden behind the spacer 30.

FIG. 3C shows the same situation as shown in FIG. 3B but with the difference that the lifting element 9 is not fully forced towards the compression plate 32, and a gap G is present. Although it is desirable to have the lifting element in contact with the compression plate or directly with the element 2, the lifting system 9 shown is capable of handling a gap G of approximately 5 cm or even more without damaging the rod when considering a CLT element of up to 1.5 tonne.

FIG. 4 shows a further embodiment of attaching the lifting element 9 to the rod 3. In this embodiment, the first end section 8 of the rod 3 comprises two rod holes 15. It is shown that the lifting element 9 is kept in position in relation to the rod, i.e. near the element 2 and the compression plate 32 if such is mounted by inserting a dowel 7 (could also be named a pin) where the dowel 7 comprises locking means 40 for keeping it securely in position. In this embodiment, the locking means is a split 40 and a head 40 but it is to be understood that other locking means may also be used e.g. simple glue or a tight fit between the dowel/pin 7 and the rod hole 15. In this embodiment, there is no need for neither the lifting element 9 nor the rod 3 to be threaded.

FIG. 5A-5G all show a rod 3 in different embodiments. It is shown that the rod 3 may comprise a thread 20 on the first end section only or that the full length of the rod 3 may comprise a thread 21. The rod holes 15 may be positioned turned 90° to each other (see e.g. FIGS. 5A and 5B) or all be oriented in the same direction (see FIG. 5C and 5E-5G). FIG. 5D shows an embodiment of the rod 3 where the rod 3 is tubular i.e. comprising an inner hole 50 along the full length of the rod 3. This implies that the rod 3 is defined by an annular wall 51. The annular wall 51 may also be partly or fully threaded on the outside.

FIG. 6 shows a CLT element 2 e.g. a floor deck lifted by attaching lifting equipment 12 to four lifting systems 1 according to the present invention. It is shown that the lifting system 1 easily handles elements with a substantial horizontal extension.

FIG. 7 shows that the element 2 shown in FIG. 6 is now joined using the lifting system without the lifting element. In other words, the lifting element is detached from the rod, and the first end section 8 of the rod 3 is inserted in receiving holes of the vertical positioned element 2. Dowels 7 are inserted, and the two elements are joined. In this way, the lifting system 1 has initially been used to lift the elements 2, and having removed the lifting element, the lifting system (without the lifting element) is now used to facilitate the joining of two elements.

In FIGS. 8A and 8B, the joining of two elements 2 is shown in a partly see-through figure (FIG. 8A) and in a solid figure (FIG. 8B similar to FIG. 7). It seen that the rod 3 is positioned in the receiving hole inside the two elements 2 substantially having the first end section 8 of the rod 3 in the one element and the second end section 11 of the rod 3 in the other element. The dowels 7 have been inserted in the dowel holes 5 in the elements and through the rod holes 15 of the rod 3.

In FIG. 8B, the same situation as in FIG. 8A is shown in a solid visualisation and now only the ends of the dowels 7 are visible together with the dowel holes 5 in the elements 2.

FIG. 9 merely shows that the same principle as shown in FIGS. 8A and 8B applies to beams to be lifted and joined, i.e. in the joined state only the end of the dowels 7 and the dowel holes are visible.

FIG. 10A shows a situation where an embodiment of the lifting system is joining two elements 2, this embodiment having rod holes that are different from circular e.g. oblong. The dowel 7 in the second end section 11 of the rod 3 is fully inserted and affixed to the element. The two elements are spaced apart by an element gap EG. The dowel 7 in the first end section 8 is in the process of being inserted in the direction shown by arrow A1 into an oblong rod hole 33. Upon forcing the dowel 7 in the first end section 8 into the oblong rod hole 33 in the rod 3, the particulars of the oblong rod hole 33 combined with the embodiment of dowel 7 having different diameter over its length i.e. the first dowel section being smaller than the second dowel section (shown in detail in FIGS. 12A and 12B) cause the one element 2 embedding the second end part 11 of the rod 3 to be pulled towards the other element 2, i.e. pulling in the direction of arrow A2. It is shown in FIG. 10B that the element gap EG no longer exists because the two elements 2 are fully drawn towards each other. It is to be understood that more dowels may be inserted, providing a stronger joining force, but the size of the gap to be able to close does not increase with an increasing number of dowels 7.

FIG. 11A shows an embodiment of the rod 3 having oblong rod holes 33. The rod 3 shown in FIG. 11A is shown in a cross-sectional view in FIG. 11B.

FIG. 11C shows an embodiment of the rod 3 where the oblong rod holes 33 are defined by two holes having their centres offset and the one hole having a diameter d1 and the second hole having a diameter d2 e.g. where d2 is 20% larger than d1. Hence, when inserting the first end 71 of the dowels shown in FIGS. 12A and 12B an oblong rod hole 33 the dowel may initially be inserted in the smaller diameter d1 and when fully inserted the larger diameter d2 will cause the rod 3 to move, i.e. pulling the two elements together as shown in FIGS. 10A and 10B.

Although the invention has been described above in connection with preferred embodiments of the invention, it will be evident to a person skilled in the art that several modifications are conceivable without departing from the invention as defined by the appended claims.

Each feature disclosed in this specification (including the accompanying claims and drawings), may be replaced by an alternative feature(s) serving the same, equivalent or similar purpose, unless expressly stated otherwise. Thus, unless expressly stated otherwise, each feature disclosed is one example only of a generic series of equivalent or similar features. In addition, all of the features disclosed in this specification (including the accompanying claims and drawings), and/or all of the steps of any method or process so disclosed, may be combined in any combination, except combinations where at least some of such features and/or steps are mutually exclusive.

Accordingly, while many different embodiments of the present invention have been described above, with preferred features, any one or more or all of the features described, illustrated and/or claimed in the appended claims may be used in isolation or in various combinations in any embodiment. As such, any one or more feature may be removed, substituted and/or added to any of the feature combinations described, illustrated and/or claimed. For the avoidance of doubt, any one or more of the features of any embodiment may be combined and/or used separately in a different embodiment with any other feature or features from any of the embodiments.

As such, the true scope of the present invention is that set out in the appended claims.

1. Lifting system (1) for lifting wooden construction elements e.g. cross laminated timber (CLT) elements, comprising:
a rod defining a longitudinal axis, a first end section and a second end section,
a lifting element connected to the rod, the lifting element comprising a lift section arranged to receive a hook, a rope, a wire or similar lifting equipment, and
a number of dowels, the dowels defining a first dowel section and second dowel section, the first and second dowel section being connected via a common section, wherein the rod comprises a number of rod holes arranged to receive the dowels, and wherein the lifting element is adapted to be detachably connected to the rod.

2. Lifting system (1) according to claim 1 wherein the rod comprises a thread at least partially along the longitudinal rod axis.

3. Lifting system (1) according to claim 1 or 2 wherein the lifting element comprises a hole arranged to receive a part of the rod.

4. Lifting system (1) according to claim 1, 2 or 3 wherein the lifting element comprises a through hole arranged to receive a hook, a shackle, a sling or similar lifting equipment.

5. Lifting system (1) according to any of the preceding claims, wherein the hole in the lifting element comprises a thread matching a thread of the rod.

6. Lifting system (1) according to any of the preceding claims wherein the lifting system further comprises a nut to keep the lifting element fixated in relation to the rod.

7. Lifting system (1) according to any of the preceding claims wherein one or more of the dowels comprises locking means for preventing the dowel to slide out of the rod hole.

8. Lifting system (1) according to any of the preceding claims wherein the rod holes in the first end section of the rod are turned 90° in relation the rod holes in the second end section of the rod.

9. Lifting system (1) according to any of the preceding claims wherein one or more rod holes are oblong.

10. Lifting system (1) according to any of the preceding claims wherein the diameter of one or more of the dowels changes over the length of the dowel.

11. Lifting system (1) according to any of the preceding claims wherein the rod is tubular.

12. Lifting system (1) according to any of the preceding claims wherein the lifting system further comprises a compression plate, the compression plate being detachably arranged between the lifting element and the part to be lifted.

13. Lifting system (1) according to any of the preceding claims wherein the lifting system comprises a spacer arranged between fastening means and the lifting element.

14. Lifting system (1) according to any of the preceding claims wherein the lift section of the lifting element is arranged at a distance from the rod in a plane substantially parallel with the longitudinal axis of the rod.

15. Lifting system (1) according to any of the preceding claims wherein the lift section is an eye and/or a projecting pin arranged to facilitate a secure connection to a hook, a rope, a wire or similar lifting equipment.
